(19) United States
(12) Patent Application Publication
(10) Pub. No.: US 2016/0139444 A1
(43) Pub. Date: May 19, 2016

(54) DISPLAY PANEL, MANUFACTURING METHOD THEREOF AND DISPLAY DEVICE

(71) Applicants: BOE TECHNOLOGY GROUP CO., LTD., Beijing (CN); BEIJING BOE OPTOELECTRONICS TECHNOLOGY CO., LTD., Beijing (CN)

(72) Inventors: Ying ZHANG, Beijing (CN); Jingpeng LI, Beijing (CN); Xin LI, Beijing (CN); Lei TANG, Beijing (CN)

(21) Appl. No.: 14/387,665

(22) PCT Filed: Dec. 6, 2013
(86) PCT No.: PCT/CN2013/088723

§ 371 Date: Sep. 24, 2014

(30) Foreign Application Priority Data
May 24, 2013 (CN) 201310196426.4

(51) Int. Cl. G02F 1/1339; G02F 1/1343; G02F 1/1335; G02F 1/1368; G02F 1/1362

(52) U.S. Cl. CPC G02F 1/13394; G02F 1/1368; G02F 1/136286; G02F 1/133514; G02F 1/133512; G02F 1/13439; G02F 2001/13398; G02F 2001/136295

(57) ABSTRACT

A display panel includes: an array substrate, which includes a gate line and a data line crossing to each other, a thin film transistor disposed in a crossing region of the gate line and the data line; a color filter substrate, cell-assembled with the array substrate; and a spacer, located between the array substrate and the color filter substrate, wherein a contact face between the spacer and the array substrate is positioned in a region of the gate line and/or a region of the data line except a region where the thin film transistor is located. A manufacturing method of a display panel and a display device also are provided.

### TECHNICAL FIELD

Embodiments of the present invention relate to a display panel, a manufacturing method thereof and a display device.

### BACKGROUND

With the rapid development of display technology, a thin film transistor liquid crystal display (TFT-LCD) as one kind of flat panel display device is more and more widely used because they have advantages of small volume, low power consumption, radiation-free, relatively low production cost, etc.

An existing TFT-LCD display is usually formed in such a way that an array substrate and a color filter substrate are cell-assembled to form a cell and liquid crystal is injected into it. A planar structure of the array substrate is shown in FIG. 1, and comprises a plurality of pixel units that are defined by gate lines 11 and data lines 12 crossing to each other and are arranged in a matrix form. A thin film transistor TFT 13 is disposed at a crossing position of the gate line 11 and the data line 12 in each of the pixel units, and a gate electrode 131 of the TFT 13 is produced on the gate line 11, its source electrode 131 is connected to the data line 12, and its drain electrode 133 is connected to a first transparent electrode 14. FIG. 2 shows a cross-sectional structure of the display taken along line A′-A in FIG. 1, and as shown in FIG. 2, each of the pixel units further comprises a second transparent electrode 15, and a gate insulating layer 16 and an active layer 17 that are located between a source/drain metal layer and a gate metal layer of the TFT 13. There is a passivation layer 18 between the first transparent electrode 14 and the second transparent electrode 15. There is a color filter substrate above the array substrate, and as shown in FIG. 2. a black matrix 21 and color filter structures 22 are formed on the color filter substrate. A pillar-shaped spacer 20 is arranged in a spacing between two or more color filtering structures 22, and serve to maintain a distance between the array substrate and the color filter substrate after cell-assembling. In FIG. 2, a top of a pillar-shaped spacer 20 contacts with a TFT 13. As such, because a contact location between the pillar-shaped spacer 20 and the array substrate is positioned over the TFT 13 and is a highest location in the array substrate, the pillar-shaped spacer 20 will automatically move toward a lower position when the panel is pressed or shocked. Moreover, it is very difficult for it to return to an original location, and thus this will lead to the light leakage. This phenomenon of light leakage has seriously degraded quality of the liquid crystal display, and reduced displaying effect of the liquid crystal display.

### SUMMARY

According to embodiments of the invention, there are provided a display panel, a manufacturing method thereof and a display device, for avoiding a phenomenon of light leakage that happens to the display panel as being squeezed or shocked, so that quality of the display panel is improved, and the display effect is promoted.

In an aspect, there is provided a display panel according to an embodiment of the invention, comprising: an array substrate, which comprises a gate line and a data line crossing to each other, a thin film transistor disposed in a crossing region of the gate line and the data line; a color filter substrate, cell-assembled with the array substrate; and a spacer, located between the array substrate and the color filter substrate, wherein a contact face between the spacer and the array substrate is positioned in a region of the gate line and/or a region of the data line except a region where the thin film transistor is located.

In another aspect, there is provided a display device according to an embodiment of the invention, comprising the display panel as stated above.

In still another aspect, there is provided a manufacturing method of a display panel according to an embodiment of the invention, comprising: producing an array substrate, which comprises a gate line and the a data line crossing to each other, a thin film transistor being disposed in a crossing region of the gate line and the data line; cell-assembling a color filter substrate and the array substrate with a spacer positioned between the array substrate and the color filter substrate, wherein, a contact face between the spacer and the array substrate is positioned in a region of the gate line and/or a region of the data line except a region where the thin film transistor is located.

### BRIEF DESCRIPTION OF THE DRAWINGS

In order to illustrate the technical solution of the embodiments of the invention more clearly, the drawings of the embodiments will be briefly described below; it is obvious that the drawings as described below are only related to some embodiments of the invention, but are not limitative of the invention.

FIG. 1 is a structurally plan view illustrating an existing pixel unit;

FIG. 2 is a cross-sectional view illustrating an existing display panel taken along line A-A′ in FIG. 1;

FIG. 3 is a structurally schematic view illustrating a vertical section of a display panel provided by an embodiment of the invention;

FIG. 4 is a structurally plan view illustrating an array substrate provided by an embodiment of the invention;

FIG. 5 is a cross-sectional view illustrating a recessed structure provided by an embodiment of the invention;

FIG. 6 is another sectional view illustrating a recessed structure provided by an embodiment of the invention; and

FIG. 7 is structurally plan view illustrating a color filter substrate provided by an embodiment of the invention.

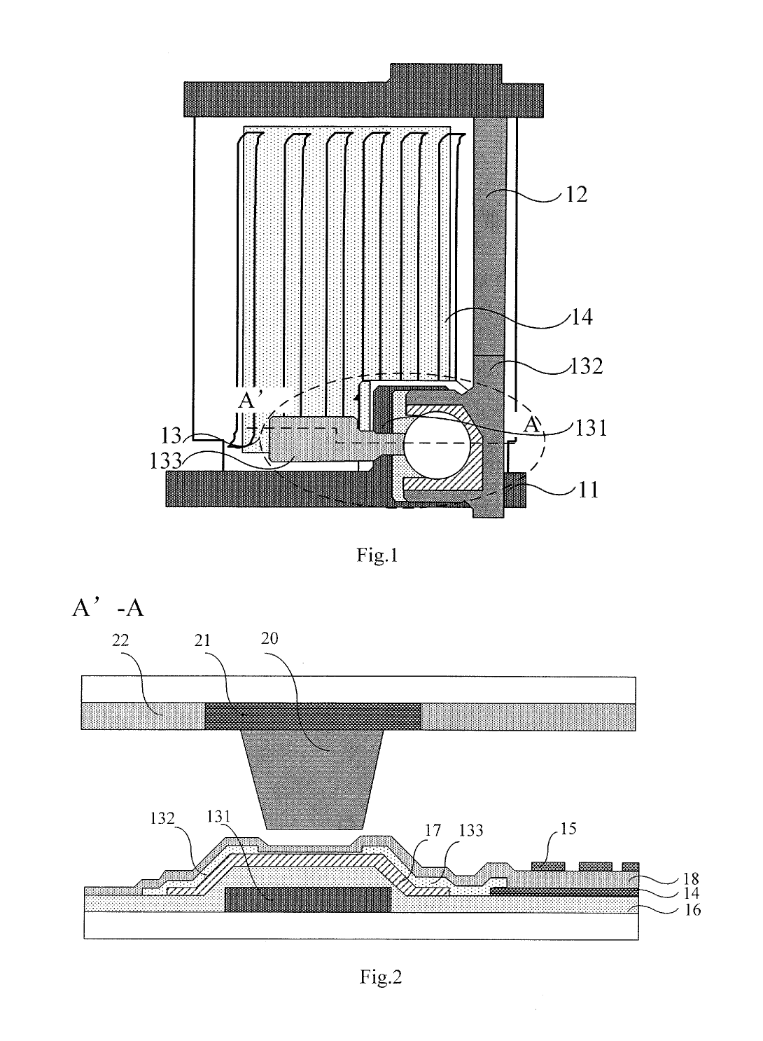

### DETAILED DESCRIPTION

In order to make objects, technical details and advantages of the embodiments of the invention apparent, the technical solutions of the embodiment will be described in a clearly and fully understandable way in connection with the drawings related to the embodiments of the invention. It is obvious that the described embodiments are just a part but not all of the embodiments of the invention. Based on the described embodiments herein, those skilled in the art can obtain other embodiment(s), without any inventive work, which should be within the scope of the invention.

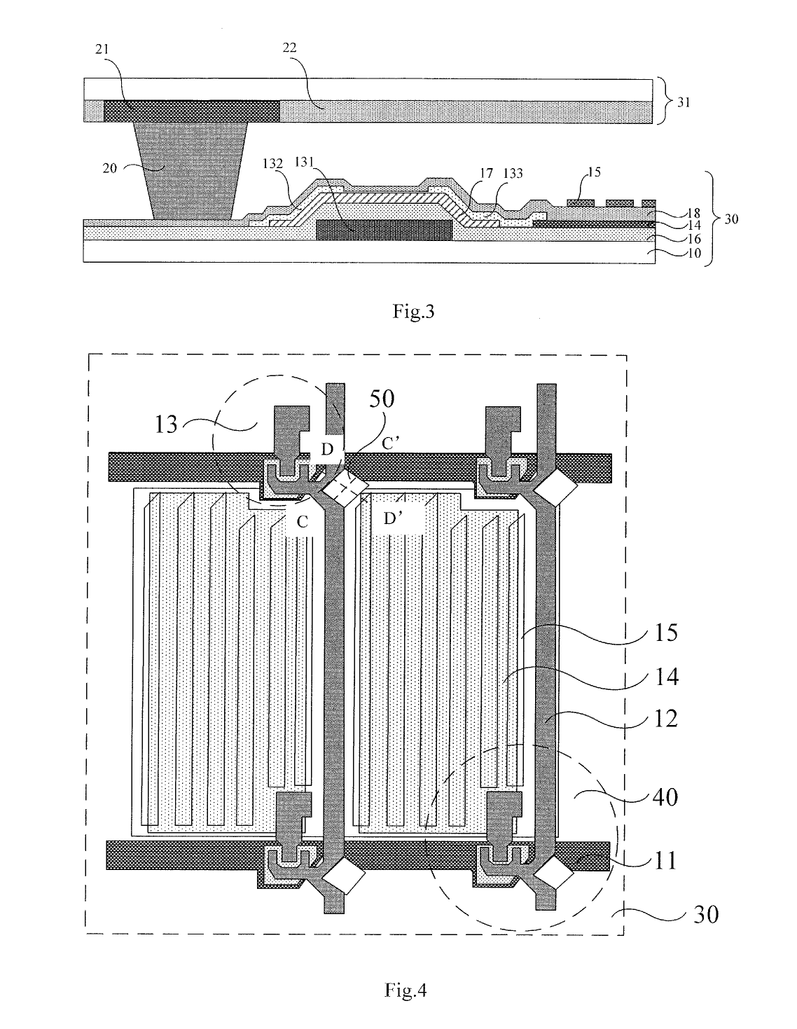

According to an embodiment of the invention, there is provided a display panel, as shown in FIG. 3, which may comprise an array substrate 30 and a color filter substrate 31 as well as a spacer 20 located between the array substrate 30 and the color filter substrate 31. Herein, as shown in FIG. 4, the array substrate 30 may comprise gate lines 11 and data lines 12 that cross to each other, and a thin film transistor TFT 13 may be disposed in a crossing region 40 of the gate line 11 and the data line 12.

Herein, a contact face 50 between the spacer 20 and the array substrate 30 may be located in a region of the gate line 11 and/or a region of the data line 12 outside a region of the TFT 13.

It is to be noted that, in terms of the display panel, the spacer 20 may be formed on a surface of the color filter substrate 31 or the array substrate 30 differentially. In each of embodiments of the invention, descriptions will be made with reference to an example in which the spacer 20 is formed on a surface of the color filter substrate 31, wherein, the spacer 20 may be formed on a surface of a black matrix 21 of the color filter substrate 31 corresponding to the region of the gate line 11 and/or the region of the data line 12 on the array substrate 30 outside the region of the TFT 13. As the color filter substrate 31 has a simple structure relative to the array substrate 30, with such a design of the spacer 20, an impact of manufacturing the spacer 20 on pixel structures on the array substrate 30 can be effectively avoided. Certainly, the spacer 20 also may be formed on a surface of the array substrate 30, and embodiments of the invention will not set a limit to this. Of course, the spacer may be a structure integrally formed with the black matrix of the color filter substrate, and no limit will be set here.

With respect to a display panel provided by embodiments of the invention that comprises an array substrate and a color filter substrate as well as a spacer located between the array substrate and the color filter substrate, the array substrate comprises a gate line and a data line crossing to each other, and a thin film transistor TFT is disposed in a crossing region of the gate line and the data line. Herein, a contact face between the spacer and the array substrate is located in a region of the gate line and/or a region of the data line outside a region of the TFT. By doing this, relative to the prior art, in view of a fact that a contact location between the spacer and the array substrate is positioned in the region of the gate line and/or the region of the data line with a uniform thickness, when the display panel is squeezed or shocked, a positional shift that results from a step on the array substrate will not happen to the spacer. Under a condition that the display panel is squeezed or shocked, a phenomenon of light leakage that happens to the display panel owing to the positional shift of the spacer can be effectively avoided, thereby improving quality of the display, and promoting the display effect remarkably.

In embodiments of the invention, the contact face 50 between the spacer 20 and the array substrate 30 is positioned in the region of the gate line 11 and/or the region of the data line 12 outside the region of the TFT 13. Exemplarity, the contact face 50 between the space 20 and the array substrate 30 may be positioned only in the region where the gate line 11 is located, the contact face 50 may be positioned only in the region where the data line 12 is located, or the contact face 50 may also be positioned in a crossing region of the gate line 11 and the data line 12.

For example, the contact face 50 between the spacer 20 and the array substrate 30 may be positioned in the crossing region of the gate line 11 and the data line 12. In the array substrate 30 shown in FIG. 4, in view of a fact that the thin film transistor TFT 13 is positioned in the crossing region 40 of the gate line 11 and the data line 12, the contact face between the spacer 20 and the array substrate 30 being positioned in the crossing region of the gate line 11 and the data line 12 means that the contact face 50 between the spacer 20 and the array substrate 30 is positioned in a non-TFT region of the crossing region of the gate line 11 and the data line 12. In the event that the contact face 50 is positioned in the region of the gate line 11 or the region of the data line 12, an area of the contact face 50 will be limited by a line width of the gate line 11 and the data line 12. So, when the contact face 50 is positioned in the crossing region of the gate line 11 and the data line 12, the area of the contact face 50 will be increased relatively. In this way, a support area of the spacer can be increased while the aperture ratio of the display panel is not affected, so that it can better play a supporting function.

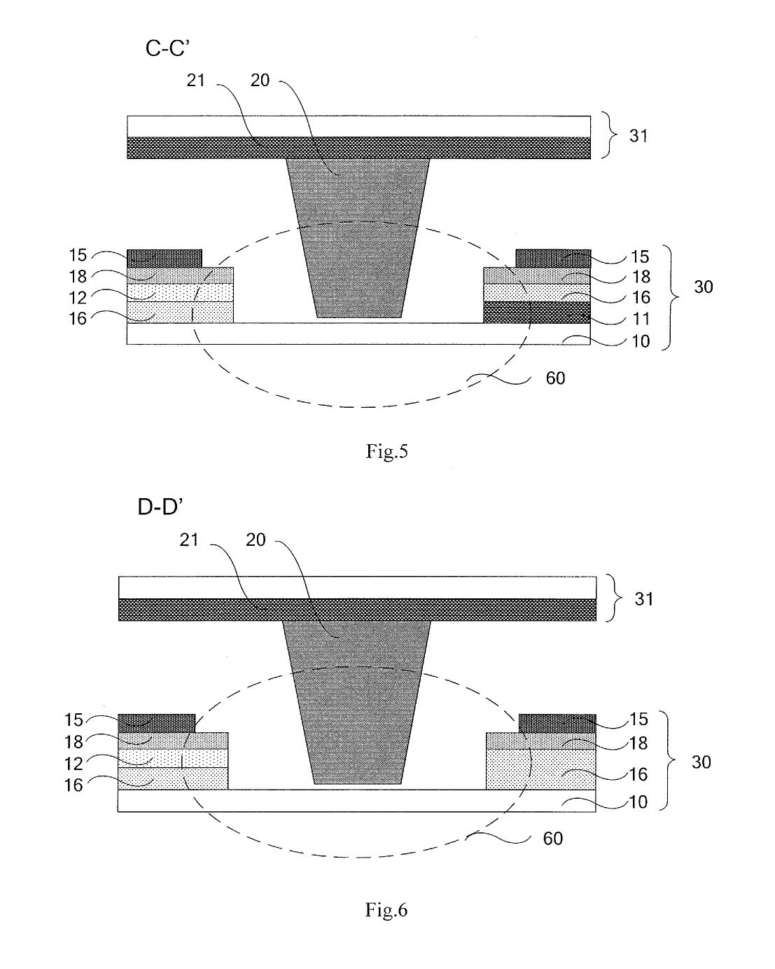

For example, as shown in FIG. 5 and FIG. 6, the array substrate 30 may further comprise a recessed structure 60, which is positioned in the region of the gate line 11 and/or the region of the data line 12; and the spacer 20 is positioned within the recessed structure 60. With such the recessed structure 60, when the display panel is squeezed, moving of the spacer can be further restricted, thereby avoiding a phenomenon of light leakage of the display panel.

Exemplarily, referring to FIG. 3 and FIG. 4, in the array substrate, the contact face 50 between the spacer 20 and the array substrate 30 is positioned at a crossing location between the gate line 11 and the data line 12. A cross-sectional view of the recessed structure 60 taken along a line C-C′ in FIG. 4 may be shown in FIG. 5, wherein, on one side of the recessed structure 60 formed by mask and etching processes, a second transparent electrode 15, a passivation layer 18, the data line 12 and a gate insulating layer 16 are disposed; and on the other side, the second transparent electrode 15, the passivation layer 18, the gate insulating layer 16 and the gate line 11 are disposed. A cross-sectional view of the recessed structure 60 taken along a line D-D′ in FIG. 4 may be shown in FIG. 6, wherein, on one side of the recessed structure 60 formed by mask and etching processes, the second transparent electrode 15, the passivation layer 18, the data line 12 and the gate insulating layer 16 are disposed; and on the other side, the second transparent electrode 15, the passivation layer 18 and the gate line 11 are disposed. As can be seen, at the crossing location of the gate line 11 and the data line 12, a small region can be etched away to form the recessed structure 60, so that the recessed structure 60 with a certain depth is formed under a condition that an electrical connection between signal lines and the aperture ratio of the pixel are not affected.

Further, as shown in FIG. 5, a transparent substrate 10 may be disposed at a bottom of the recessed structure 60.

It is to be noted that, the recessed structure 60 is formed by using an etch process at a location where the contact face 50 between the spacer 20 and the array substrate 30 is positioned, and thus, owing to different etch depths, a layer where the bottom of the recessed structure 60 is positioned lies in different levels accordingly. For example, during the etch process, the gate insulating layer 60 and the passivation layer 18 may be not removed or be partially removed. As such, the recessed structure 60 with a required depth can be made by those skilled in the art according to the actual situations during implementation of the processing. When layer structures at the location where the contact face 50 is positioned are completely etched away, at the bottom of the recessed structure 60 is just the transparent substrate 10. In this way, a step different between the recessed structure 60 and a peripheral structure can be decreased to the maximum degree, so that moving of the spacer 20 in the recessed structure 60 is effectively restricted.

Further, as shown in FIG. 4, an opening shape of the recessed structure (not shown in figure) may be a diamond. In this way, the crossing region of the gate line 11 and the data line 12 can be utilized more fully. When upper and lower base faces of the spacer 20 are formed as a diamond that has the same opening shape as the recessed structure and a slightly smaller opening size, an area of the contact face 50 between the spacer 20 and the array substrate 30 can be maximized. As such, a supporting area of the spacer 20 is increased while moving of the spacer 20 is effectively restricted. Thus, the moving of the spacer is further restricted while the aperture ratio of the pixel is guaranteed, and the supporting effect of the spacer 20 is promoted.

Further, a side length of the diamond may be in the range of 5 μm-8 μm, and as such, when four included angles of the diamond are 90 degrees, i.e. the opening shape of the recessed structure 60 is a square, a diagonal length of the square may be in the range of 7 μm-10 μm. Thus, the area of the contact face 50 between the spacer 20 and the array substrate 30 is maximized, and the supporting effect of the spacer 20 is promoted more effectively. It should be understood that, descriptions made above are merely illustrative examples of the location where the recessed structure 60 is positioned and its shape, and the recessed structure 60 may be adjusted accordingly in accordance with the actual structure of a substrate. Embodiments of the invention do not set a limit to this.

Further, as shown in FIG. 5, a vertical section of the spacer 20 is constructed as an isosceles trapezoid.

A lower base of the isosceles trapezoid may contact with the color filter substrate 31, and a upper base of the isosceles trapezoid may contact with the array substrate 30; alternatively, the lower base of the isosceles trapezoid may contact with the array substrate 30, and the upper base of the isosceles trapezoid may contact with the color filter substrate 31.

Herein, the lower base of the isosceles trapezoid is parallel to its upper base, and the length of the lower base is larger than the length of the upper base. As such, the spacer 20 may be formed on the color filter substrate 31, and may also be formed on the array substrate 30. Thus, this makes a production process more flexible. In comparison, as shown in FIG. 5, the layer structure of the color filter substrate 31 is relatively simple, and so, the spacer 20 can be produced on the color filter substrate 31. By doing this, an impact of forming the spacer 20 on pixel structures on the array substrate 30 can be avoided effectively, and moreover, the process also can be simplified, and the production efficiency is improved.

It is to be noted that, the vertical section of the spacer 20 is the isosceles trapezoid, and with such the isosceles trapezoid structure, forces exerted on the spacer 20 can be dispersed evenly to two sides of the trapezoid, so that the supporting effect of the spacer 20 can be promoted. Further, upper and lower faces of the spacer 20 may adopt any pattern, such as a circle, a quadrangle or other polygon, or the like. Exemplarily, when the opening shape of the recessed structure 60 is a diamond, the spacer 20 may employ a diamond that has the same opening shape as the recessed structure 60 and a slightly smaller opening size; and in this way, moving of the spacer 20 can be restricted better.

Further, for example, the lower base of the isosceles trapezoid may be in the range of 1 μm-20 μm, and the upper base of the isosceles trapezoid may be in the range of 1 μm-10 μm.

It is to be noted that, the display panel provided by embodiments of the invention may be applicable to liquid crystal display products in various modes comprising TN (Twisted Nematic), IPS (In-Plane Switching), FFS (Fringe Field Switching), ADS (Advanced Super Dimension Switch), etc., and embodiments of the invention do not set a limit to this. Herein, the ADS mode is a core technique of flat electric field and wide viewing-angle, its technical characteristics is in that: an electric field generated by fringes of slit electrodes in the same plane and an electric field generated between the slit electrode layer and a plate electrode layer can constitute a multi-dimension electric field, so as to make liquid crystal molecules oriented in all directions between the slits electrodes and directly above the electrodes inside a liquid crystal cell capable of rotating, thus improving the operating efficiency of liquid crystal and increasing the light transmittance. The ADS technology can improve the displaying quality of a TFT-LCD, and has advantages of high resolution, high transmittance, low power consumption, wide viewing angle, high aperture ratio, low chromatic aberration, no push Mura, etc. For different applications, improved technologies of the ADS technology are high-transmittance I-ADS technology, high aperture ratio H-ADS, high-resolution S-ADS technology, and so on.

In the display panel shown in FIG. 3, an ADS mode liquid crystal panel is shown as an example. Herein, the array substrate 30 comprises a plane-shaped first transparent electrode 14 and a strip-shaped second transparent electrode 15 that are disposed in different layers, and as compared with a TN mode liquid crystal display panel, the ADS mode liquid crystal panel has a larger viewing angle and a higher contrast.

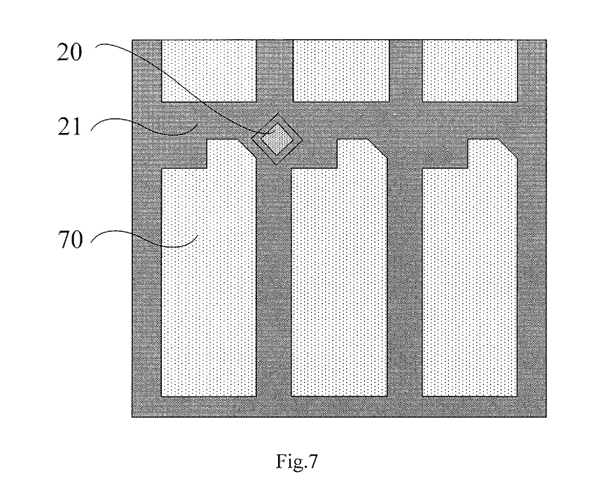

In an embodiment of the invention, the spacer 20 may be formed on a surface of the color filter substrate 31, and the spacer 20 may be formed on a surface of a black matrix 21 of the color filter substrate 31 in correspondence with the region of the gate line 11 and/or the region of the data line 12 on an array substrate 30 outside the region of the TFT 13. For example, when a recessed structure on the array substrate 30 is a diamond structure at a crossing location of the gate line 11 and the data line 12, the spacer 20 may correspond to the recessed structure on the array substrate. As shown in FIG. 7, the spacer 20 also can adopt a diamond structure disposed at the crossing location of the gate line 11 and the data line 12. Because the color filter substrate 31 has a simple structure relative to the array substrate 30, with such a design of spacer 20, an impact of manufacturing the spacer on pixel structures on the array substrate 30 can be effectively avoided.

It is to be noted that, as shown in FIG. 7, shapes of upper and lower base faces of the spacer 20 may correspondingly change a shape of a pixel opening region 70 in the color filter substrate 31. When the shapes of upper and lower base faces of the spacer 20 are diamond, a top-left corner of the pixel opening region 70 at a place corresponding to the spacer 20 is sheltered by a part of the diamond.

In the display panel with such a structure, in view of a fact that the contact location between the spacer 20 and the array substrate 30 is positioned in the region of the gate line 11 and/or the region of the data line 12 with a uniform thickness, when the display panel is squeezed or shocked, a positional shift that results from a step difference on the array substrate 30 will not happen to the spacer 20. A phenomenon of light leakage that happens to the display panel owing to the positional shift of the spacer when the display panel is squeezed or shocked is effectively avoided, thereby improving quality of the display panel, and promoting the display effect remarkably.

According to an embodiment of the invention, there is provided a display device, comprising any display panel as mentioned above. The display device may be: a liquid crystal panel, an electronic paper, an organic light-emitting panel, a liquid crystal television, a liquid crystal display, a digital photoframe, a cell phone, a tablet computer, or any other product or component having a display function. It has the same beneficial effect as the display panel provided by forgoing embodiments of the invention, and as the display panel has been described in detail in forgoing embodiments, details are omitted here.

Regarding a display device provided by embodiments of the invention, it comprises a display panel. The display panel comprises an array substrate and a color filter substrate as well as a spacer located between the array substrate and the color filter substrate, the array substrate comprises a gate line and a data line crossing to each other, and a thin film transistor TFT is disposed in a crossing region of the gate line and the data line. Herein, a contact face between the spacer and the array substrate is positioned in a region of the gate line and/or a region of the data line outside a region of the TFT. By doing this, as compared to prior art, in view of a fact that the contact location of the spacer with the array substrate is positioned in the region of the gate line and/or the region of the data line with a uniform thickness, when the display panel is squeezed or shocked, a positional shift that results from a step difference on the array substrate will not happen to the spacer. A phenomenon of light leakage that happens to the display panel owing to the positional shift of the spacer when being squeezed or shocked is effectively avoided, thereby improving quality of the display panel, and promoting the display effect remarkably.

According to an embodiment of the invention, there is provided a manufacturing method of a display panel. Referring to FIG. 3 and FIG. 4, the method comprises:

S101, an array substrate 30 is formed, the array substrate 30 may comprise a gate line 11 and a data line 12 crossing to each other, and a thin film transistor TFT 13 may be disposed in a crossing region 40 of the gate line 11 and the data line 12.

S102, a color filter substrate 31 and the array substrate 30 are cell-assembled, and there may be a spacer 20 between the array substrate 30 and the color filter substrate 31.

Herein, a contact face 50 of the spacer 20 and the array substrate 30 may be positioned in a region of the gate line 11 and/or a region of the data line 12 outside a region of the TFT 13.

A manufacturing method of a display panel is provided by embodiments of the invention. The display panel comprises an array substrate and a color filter substrate as well as a spacer located between the array substrate and the color filter substrate, the array substrate comprises a gate line and a data line crossing to each other, and a thin film transistor TFT is disposed in a crossing region of the gate line and the data line. Herein, a contact face between the spacer and the array substrate is positioned in a region of the gate line and/or a region of the data line outside a region of the TFT. By doing this, as compared to prior art, in view of a fact that a contact location of the spacer with the array substrate is positioned in the region of the gate line and/or the region of the data line with a uniform thickness, when the display panel is squeezed or shocked, a positional shift that results from a step difference on the array substrate will not happen to the spacer. A phenomenon of light leakage that happens to the display panel owing to the positional shift of the spacer when being squeezed or shocked is effectively avoided, thereby improving quality of the display panel, and promoting the display effect remarkably.

It is to be noted that, the display panel provided by embodiments of the invention may be applicable to liquid crystal display products in various modes comprising TN, IPS, FFS, ADS, and so on, and embodiments of the invention do not set a limit to this.

For example, as shown in FIG. 3, with an ADS mode liquid crystal display device as an example, manufacturing the array substrate 30 comprises:

S201, a pattern comprising the gate line 11 and a gate electrode 131 of the TFT is formed on a surface of a transparent substrate 10 through one patterning process;

S202, a pattern comprising a gate insulating layer 16 is formed on a surface of the gate electrode 131 of the TFT through one patterning process;

S203, a pattern comprising an active layer 17 is formed on a surface of the gate insulating layer 16 through one patterning process;

S204, a pattern comprising a transparent electrode is formed on the substrate with the above structures formed thereon through one patterning process.

S205, a patterning comprising a source electrode 132 of the TFT, a drain electrode 133 of the TFT and a data line is formed on the substrate with the above structures formed thereon through one patterning process.

S206, a recessed structure is formed in a crossing region of the gate line 11 and the data line 12 by etching.

It is to be noted that, the ADS mode product is shown in FIG. 3 as an example, and so there are two layers of transparent electrodes in the array substrate, comprising a first transparent electrode 14 and a second transparent electrode 15.

It is to be noted that, during producing the array substrate 30, there are many ways of producing the recessed structure. For example, in the above step S205, it is also possible that the gate line 11 and the data line 12 with bent portions as shown in FIG. 4 are produced with a mask designed beforehand, and by doing this, the recessed structure is formed in a crossing region of the gate line 11 and the data line 12. Certainly, there are many ways of forming the recessed structure, which will not be described with examples one by one. However, every display panel with the recessed structure in a region of the gate line 11 or the data line 12 shall be within the protection scope of embodiments of the invention.

In this way, the array substrate 30 with the recessed structure can be completed, so that the spacer 20 can be placed in the recessed structure. Thus, moving the spacer 20 is restricted, and a phenomenon of light leakage of the display panel is avoided.

For example, as shown in FIG. 5, a transparent substrate 10 may be disposed at a bottom of the recessed structure 60.

It is to be noted that, the recessed structure 60 is formed by using an etch process at a location where the contact face 50 between the spacer 20 and the array substrate 30 is positioned, and thus, owing to different etch depths, a layer where the bottom of the recessed structure 60 is positioned lies in different levels accordingly. For example, during the etch process, the gate insulating layer 60 and the passivation layer 18 may be not removed or be partially removed. As such, the recessed structure 60 with a required depth can be made by those skilled in the art according to the actual situations during implementation of the processing. When layer structures at the location where the contact face 50 is positioned are completely etched away, at the bottom of the recessed structure 60 is just the transparent substrate 10. In this way, a step different between the recessed structure 60 and a peripheral structure can be decreased to the maximum degree, so that moving of the spacer 20 in the recessed structure 60 is effectively restricted.

Further, as shown in FIG. 4, an opening shape of the recessed structure (not shown in figure) may be a diamond. In this way, the crossing region of the gate line 11 and the data line 12 can be utilized more fully. When upper and lower base faces of the spacer 20 are formed as a diamond that has the same opening shape as the recessed structure and a slightly smaller opening size, an area of the contact face 50 between the spacer 20 and the array substrate 30 can be maximized. As such, a supporting area of the spacer 20 is increased while moving of the spacer 20 is effectively restricted. Thus, the moving of the spacer is further restricted while the aperture ratio of the pixel is guaranteed, and the supporting effect of the spacer 20 is promoted.

Further, a side length of the diamond may be in the range of 5 μm-8 μm, and as such, when four included angles of the diamond are 90 degrees, i.e. the opening shape of the recessed structure 60 is a square, a diagonal length of the square may be in the range of 7 μm-10 μm. Thus, the area of the contact face 50 between the spacer 20 and the array substrate 30 is maximized, and the supporting effect of the spacer 20 is promoted more effectively. It should be understood that, descriptions made above are merely illustrative examples of the location where the recessed structure is positioned and its shape, and the recessed structure may be adjusted accordingly in accordance with the actual structure of a substrate. Embodiments of the invention do not set a limit to this.

Further, as shown in FIG. 5, a vertical section of the spacer 20 is constructed as an isosceles trapezoid.

A lower base of the isosceles trapezoid may contact with the color filter substrate 31, and a upper base of the isosceles trapezoid may contact with the array substrate 30; alternatively, the lower base of the isosceles trapezoid may contact with the array substrate 30, and the upper base of the isosceles trapezoid may contact with the color filter substrate 31.

Herein, the lower base of the isosceles trapezoid is parallel to its upper base, and the length of the lower base is larger than the length of the upper base. As such, the spacer 20 may be formed on the color filter substrate 31, and may also be formed on the array substrate 30. Thus, this makes a production process more flexible. In comparison, as shown in FIG. 5, the layer structure of the color filter substrate 31 is relatively simple, and so, the spacer 20 can be produced on the color filter substrate 31. By doing this, an impact of forming the spacer 20 on pixel structures on the array substrate 30 can be avoided effectively, and moreover, the process also can be simplified, and the production efficiency is improved.

It is to be noted that, the vertical section of the spacer 20 is the isosceles trapezoid, and with such the isosceles trapezoid structure, forces exerted on the spacer 20 can be dispersed evenly to two sides of the trapezoid, so that the supporting effect of the spacer 20 can be promoted. Further, upper and lower faces of the spacer 20 may adopt any pattern, such as a circle, a quadrangle or other polygon, or the like. Exemplarily, when the opening shape of the recessed structure 60 is a diamond, the spacer 20 may employ a diamond that has the same opening shape as the recessed structure 60 and a slightly smaller opening size; and in this way, moving of the spacer 20 can be restricted better.

For example, for example, a lower base of the isosceles trapezoid may be in the range of 1 μm-20 μm, and a upper base of the isosceles trapezoid may be in the range of 1 μm-10 μm.

Exemplarily, a manufacturing method of an array substrate will be described in detail with an ADS display panel as an example, in connection with FIG. 3, FIG. 4 and FIG. 5.

S301, a layer of metal thin film with a thickness of 1000 Å-7000 Å is formed on a transparent substrate 10 (e.g. by using a magnetron sputtering method). A pattern comprising a gate line 11 and a gate electrode 131 is formed by a first mask and etching process.

S302, a gate insulating layer 16 with a thickness of 1000 Å-6000 Å is formed on the substrate with the above structure (e.g. by using a chemical vapor deposition method), and a pattern comprising the gate insulating layer 16 is formed.

S303, an active layer material is formed on the substrate with the above structure (e.g. by way of deposition), and is formed into a pattern comprising an active layer 17 by a second mask and etching process.

S304, a transparent conductive electrode material is formed on the substrate with the above structure (e.g. by way of deposition), and is formed into a first transparent electrode 14 by a third mask and etching process. Material for the first transparent electrode 14 may be ITO, and a thickness of the first transparent electrode 14 may be in the range of 100 Å-1000 Å.

S305, a source/drain electrode material is formed on the substrate with the above structure (e.g. by way of deposition), and is formed into a data line 12 and a source electrode 132 and a drain electrode 133 of a TFT by a fourth mask and etching process with a mask for the source and drain electrodes.

S306, a passivation layer material is formed on the substrate with the above structure (e.g. by way of deposition), and is formed into a pattern comprising a passivation layer 18.

S307, a transparent conductive electrode material is formed on the substrate with the above structure formed (e.g. by way of deposition), and is formed into a second transparent electrode 15 by a fifth mask and etching process, as shown in FIG. 3.

S308, in a crossing region of the data line 12 and the gate line 11 and with a mask for a recessed structure, the gate insulating layer 16 and the passivation layer 18 are fully removed by a fifth mask and etching process, so as to form the recessed structure 60. An opening of the recessed structure 60 is a diamond as shown in FIG. 4.

In the display panel with such a structure, in view of a fact that a contact location between the spacer 20 and the array substrate 30 is positioned in a region of the gate line 11 and/or a region of the data line 12 with a uniform thickness, when the display panel is squeezed or shocked, a positional shift that results from a step difference on the array substrate 30 will not happen to the spacer 20. A phenomenon of light leakage that happens to the display panel owing to the positional shift of the spacer when being squeezed or shocked is effectively avoided, thereby improving quality of the display panel, and promoting the display effect remarkably.

In embodiments of the invention, the patterning process may merely comprise a photolithography process, or comprise a photolithography process and an etch process, and besides, it may also comprise printing, inkjet or other process for forming a preset pattern; the photolithography process refers to a process comprising photoresist coating, exposure, development and other technological process in which a pattern is formed by using a photoresist, a mask, a lithography equipment and so on. It is possible that a corresponding patterning process is chosen according to a structure formed in embodiments of the invention.

With respect to a display panel, a manufacturing method thereof and a display device provided by embodiments of the invention, the display panel comprises an array substrate and a color filter substrate as well as a spacer located between the array substrate and the color filter substrate, the array substrate comprises a gate line and a data line crossing to each other, and a thin film transistor TFT is disposed in a crossing region of the gate line and the data line. Herein, a contact face between the spacer and the array substrate is positioned in a region of the gate line and/or a region of the data line outside a region of the TFT. By doing this, as compared to prior art, in view of a fact that the contact location of the spacer with the array substrate is positioned in the region of the gate line and/or the region of the data line with a uniform thickness, when the display panel is squeezed or shocked, a positional shift that results from a step difference on the array substrate will not happen to the spacer. A phenomenon of light leakage that happens to the display panel owing to the positional shift of the spacer when being squeezed or shocked is effectively avoided, thereby improving quality of the display panel, and promoting the display effect remarkably.

The embodiment of the invention being thus described, it will be obvious that the same may be varied in many ways. Such variations are not to be regarded as a departure from the spirit and scope of the invention, and all such modifications as would be obvious to those skilled in the art are intended to be included within the scope of the following claims.

1. A display panel, comprising:
an array substrate, which comprises a gate line and a data line crossing to each other, a thin film transistor disposed in a crossing region of the gate line and the data line;
a color filter substrate, cell-assembled with the array substrate; and
a spacer, located between the array substrate and the color filter substrate, wherein a contact face between the spacer and the array substrate is positioned in a region of the gate line and/or a region of the data line except a region where the thin film transistor is located.

2. The display panel claimed as claim 1, wherein, the contact face between the spacer and the array substrate is positioned in the crossing region of the gate line and the data line.

3. The display panel claimed as claim 1, wherein, the array substrate further comprises a recessed structure positioned in the region of the gate line and/or the region of the data line; and the spacer is positioned within the recessed structure.

4. The display panel claimed as claim 3, wherein at a bottom of the recessed structure, there is disposed a transparent substrate as a base substrate of the array substrate.

5. The display panel claimed as claim 3, wherein, an opening shape of the recessed structure is a diamond.

6. The display panel claimed as claim 5, wherein, a side length of the diamond is in the range of 5 μm -8 μm.

7. The display panel claimed as claim 1, wherein, a vertical section of the spacer is constructed as an isosceles trapezoid;
a lower base of the isosceles trapezoid contacts with the color filter substrate, and a upper base of the isosceles trapezoid contacts with the array substrate; or,
the lower base of the isosceles trapezoid contacts with the array substrate, and the upper base of the isosceles trapezoid contacts with the color filter substrate; and
the lower base of the isosceles trapezoid is parallel to the upper base, and length of the lower base is larger than or equal to length of the upper base.

8. The display panel claimed as claim 7, wherein, the lower base of the isosceles trapezoid is in the range of 1 μm-20 μm, and the upper base of the isosceles trapezoid is in the range of 1 μm-10 μm.

9. The display panel claimed as claim 1, wherein, the spacer is formed on the array substrate or the color filter substrate.

10. The display panel claimed as claim 9, wherein, under a condition that the spacer is formed on the color filter substrate, the spacer and a black matrix of the color filter substrate are formed into an integral body.

11. The display panel claimed as claim 3, wherein, at a bottom of the recessed structure, there is disposed a gate insulating layer of the array substrate.

12. The display panel claimed as claim 1, wherein, shapes of upper and lower sections of the spacer are a circle or a quadrangle.

13. A display device, comprising the display panel claimed as claim 1.

14. A manufacturing method of a display panel, comprising:
producing an array substrate, which comprises a gate line and the a data line crossing to each other, a thin film transistor being disposed in a crossing region of the gate line and the data line;
cell-assembling a color filter substrate and the array substrate with a spacer positioned between the array substrate and the color filter substrate,
wherein, a contact face between the spacer and the array substrate is positioned in a region of the gate line and/or a region of the data line except a region where the thin film transistor is located.

15. The manufacturing method claimed as claim 14, wherein, the producing of the array substrate comprises:
forming a pattern that comprises the gate line and a gate electrode of the thin film transistor on a surface of a transparent substrate through one patterning process;
forming a pattern that comprises a gate insulating layer on a surface of the gate electrode of the thin film transistor through one patterning process;
forming a pattern that comprises an active layer on a surface of gate insulating layer through one patterning process;
forming a pattern that comprises a transparent electrode on the substrate with the above structures formed through one patterning process;
forming a pattern that comprises source and drain electrodes of the thin film transistor and the data line on the substrate with the above structure formed through one patterning process;
forming a recessed structure in a crossing region of the gate line and the data line by etching.

16. The manufacturing method claimed as claim 15, wherein the transparent substrate is disposed at a bottom of the recessed structure.

17. The manufacturing method claimed as claim 15, wherein, an opening shape of the recessed structure is a diamond.

18. The manufacturing method claimed as claim 17, wherein, a side length of the diamond is in the range of 5 μm-8 μm.

19. The manufacturing method claimed as claim 14, wherein, a vertical section of the spacer is constructed as an isosceles trapezoid;
a lower base of the isosceles trapezoid contacts with the color filter substrate, and a upper base of the isosceles trapezoid contacts with the array substrate; or, the lower base of the isosceles trapezoid contacts with the array substrate, and the upper base of the isosceles trapezoid contacts with the color filter substrate; and
the lower base of the isosceles trapezoid is parallel to the upper base, and length of the lower base is larger than or equal to length of the upper base.

20. The manufacturing method claimed as claim 19, wherein, the lower base of the isosceles trapezoid is in the range of 1 μm-20 μm, and the upper base of the isosceles trapezoid is in the range of 1 μm-10 μm.
